(19) United States
(12) Patent Application Publication
(10) Pub. No.: US 2025/0083730 A1
(43) Pub. Date: Mar. 13, 2025

(54) SKI SYSTEM FOR A BICYCLE AND SKI BICYCLE

(71) Applicant: Hans J. Laudon, Phoenix, AZ (US)

(72) Inventor: Hans J. Laudon, Phoenix, AZ (US)

(21) Appl. No.: 18/243,648

(22) Filed: Sep. 7, 2023

(51) Int. Cl. B62B 13/18; B62K 13/00

(52) U.S. Cl. CPC B62B 13/18; B62K 13/00; B62B 13/043; B62J 11/05

(57) ABSTRACT

A ski system for a bicycle including a bicycle having a front wheel and a rear wheel, a ski, and an attachment assembly attaching the ski to the wheels in the skied configuration. The attachment assembly includes a front binding and a rear binding attached to the ski for removably receiving the front wheel and the rear wheel, respectively, in the skied configuration. A front tension cord system and a rear tension cord system are couplable between the ski and the front wheel and rear wheel, respectively, in the skied configuration.

### FIELD OF THE INVENTION

This invention relates to recreational equipment and, more particularly, to ski equipment and bicycles.

### BACKGROUND OF THE INVENTION

The use of skis and mountain bikes are each popular sporting activities. As with many sports and activities, there is a desire to combine the activities or make each useful to the other. Many people find pleasure riding their mountain bikes on snowy backcountry trails or in alpine/mountainous regions with partial snow conditions. However, many outdoor enthusiasts find it especially difficult and even dangerous to attempt to ride their bikes down snowy hills, especially when the hill is steep or the snow is deep. Additionally, seated ski devices are gaining some popularity. These devices can be very difficult to transport to the top of a slope.

Currently, there are various systems for converting bicycles to ski bikes. While somewhat effective, they are generally unwieldy, requiring restructuring the bicycle, such as removing the wheels, and the like. This requires storage of access parts, extensive time for the conversion, adjustments for the rider's position and less robust construction. They also tend to be heavy in weight making uphill transport more strenuous or impractical. In view of this, it would be highly advantageous to provide adventurous people with the ability to easily and effortlessly combine the benefits of cycling, and especially mountain biking, with the enjoyment of skiing. Thus, there is a need for a bicycle and a ski system for converting the bicycle between wheeled and skied configurations very quickly and for providing a rider with the ability to switch between wheeled navigation and ski navigation.

It would be highly advantageous, therefore, to remedy the foregoing and other deficiencies inherent in the prior art.

### SUMMARY OF THE INVENTION

Briefly, to achieve the desired objects and advantages of the instant invention provided is a ski system for converting a bicycle to a ski bicycle. The ski system includes a bicycle with a frame having a front fork, a first release fastener releasably coupling a front wheel to the front fork, a rear fork, and a second release fastener releasably coupling a rear wheel to the rear fork, a ski having a front end and a back end, the ski attachable to the frame in a wheeled configuration and attachable to the wheels and axle points in a skied configuration, and an attachment assembly removably securing the front wheel and the rear wheel to the ski in the skied configuration. The attachment assembly includes a front binding attached to the ski proximate the front end and removably receiving the front wheel in the skied configuration, a rear binding attached to the ski proximate the rear end and removably receiving the rear wheel in the skied configuration, a front tension cord system couplable between the ski and the front wheel axle point in the skied configuration, and a rear tension cord system couplable between the ski and the rear wheel axle point in the skied configuration.

In a specific aspect of the invention, the front binding and the rear binding each include a rigid base, a buckle securely attached to a side of the base, and a strap securely attached to an opposing side of the base, the strap having a free end adjustably and releasably engageable to the buckle.

In yet a further aspect, the front tension cord system and the rear tension cord system each include a pair of hooks or small pulley hangers mounted one on either side of one of the front wheel and the rear wheel at the axle points and are captured between one of the first release fastener and the corresponding one of the front fork and the rear fork. A pair of anchors are formed in the ski proximate one of the front end and rear end thereof. A pair of tightening carabiners are attached to the ski one of rearwardly of the front binding or forwardly of the rear binding. A pair of tension cords each have an end attached to one of the pair of anchors at the front end or the back end, one each engaging one each of the pair of hooks on the front wheel or the back wheel, and one each passing through one each of the tightening carabiners, the pair of tensioning cords movable between a loosened configuration and a tightened configuration securing one of the front wheel and the rear wheel to the ski in the skied configuration.

In yet another aspect, provided is a ski bicycle including a bicycle with a frame having a front fork, a first release fastener releasably coupling a front wheel to the front fork, a rear fork, and a second release fastener releasably coupling a rear wheel to the rear fork. A ski is also provided having a front end and a back end, the ski is attached to the front wheel and the back wheel. An attachment assembly removably secures the front wheel and the rear wheel to the ski. The attachment assembly includes a front binding attached to the ski proximate the front end, the front wheel removably received therein, a rear binding attached to the ski proximate the rear end, the rear wheel removably received therein, a front tension cord system coupled between the ski and the front wheel, and a rear tension cord system coupled between the ski and the rear wheel.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a side elevational view of a bicycle including front and rear wheels attached to a frame and a ski carried by the bicycle in a wheeled configuration, in accordance with the invention;

FIG. 2 is a side elevational view of the bicycle and the ski of FIG. 1 with an attachment assembly attaching the ski to the bicycle in a skied configuration;

FIG. 3 is a perspective view of the bicycle and ski of FIGS. 1 and 2, with the attachment assembly partially disassembled;

FIG. 4 is an enlarge partial view of a coupling member coupling the ski to the frame in the wheeled configuration;

FIG. 5 is an enlarged partial view of a coupling member coupling the ski to the seat post in the wheeled configuration;

FIG. 6 is an enlarged partial view of the front wheel showing front axle hanger ready to connect hooks mounted on the front axle;

FIG. 7 is an enlarged partial view of the rear wheel showing rear axle hanger ready to connect hooks mounted on the rear axle;

FIG. 8 is an enlarged partial view of the rear binding;

FIG. 9 is an enlarged partial view of the front binding;

FIG. 10 is a perspective view of the bicycle and ski of FIGS. 1 and 2, with the front wheel and the rear wheel received in the front binding and the rear binding;

FIG. 11 is an enlarged partial view of the front binding engaging the front wheel;

FIG. 12 is an enlarged partial view of the paired eyebolts and tightener carabiners;

FIG. 13 is an enlarged partial perspective view illustrating looping the tensioning cord on a hook;

FIG. 14 is an enlarged partial perspective view of the front tension cord system in a loose configuration;

FIG. 15 is an enlarged partial perspective view of the front tension cord system being moved to the tightened configuration;

FIG. 16 is an enlarged partial perspective view of the rear tension cord system in a tightened configuration;

FIG. 17 is an enlarged partial rear view of the rear tension cord system in a tightened configuration; and

FIG. 18 is an enlarged partial perspective view of the ski wraps holding the brakes in an engaged configuration.

### DETAILED DESCRIPTION OF THE PREFERRED EMBODIMENT

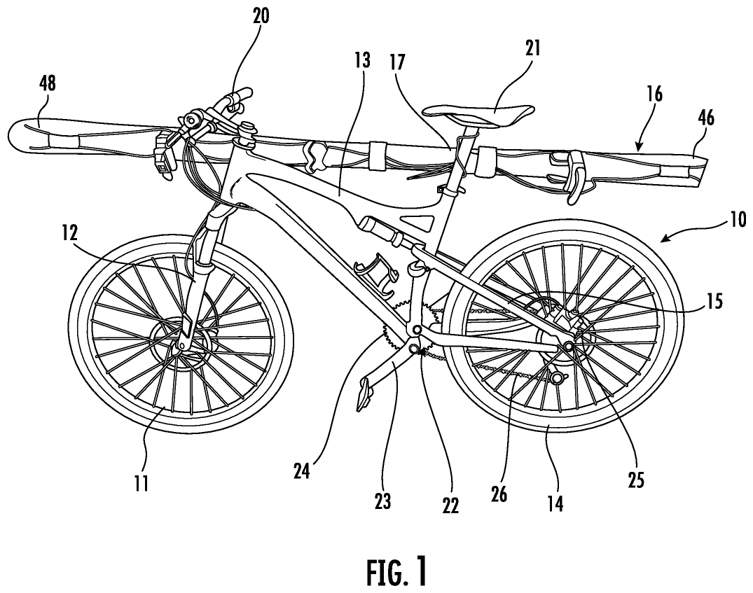

Turning now to the drawings in which like reference characters indicate corresponding elements throughout the several views, attention is first directed to FIG. 1 which illustrates a bicycle 10 including a front wheel 11 attached to front forks 12 at a forward or leading end of a frame 13, and a rear wheel 14 attached to rear forks 15 at a rearward or trailing end of frame 13. A ski 16 is removably coupled to frame 13 by coupling members 17. Bicycle 10 is illustrative of a typical mountain bike, and it is equipped with ordinary features, namely, a handle bar 20 attached at the forward end of frame 13, a saddle or seat and seat post 21 attached at the rearward end of frame 13, a pedaled drive assembly 22 including a crank 23 associated with front gears 24 and which are coupled to rear gears 25 carried by rear wheel 14 with an endless chain 26.

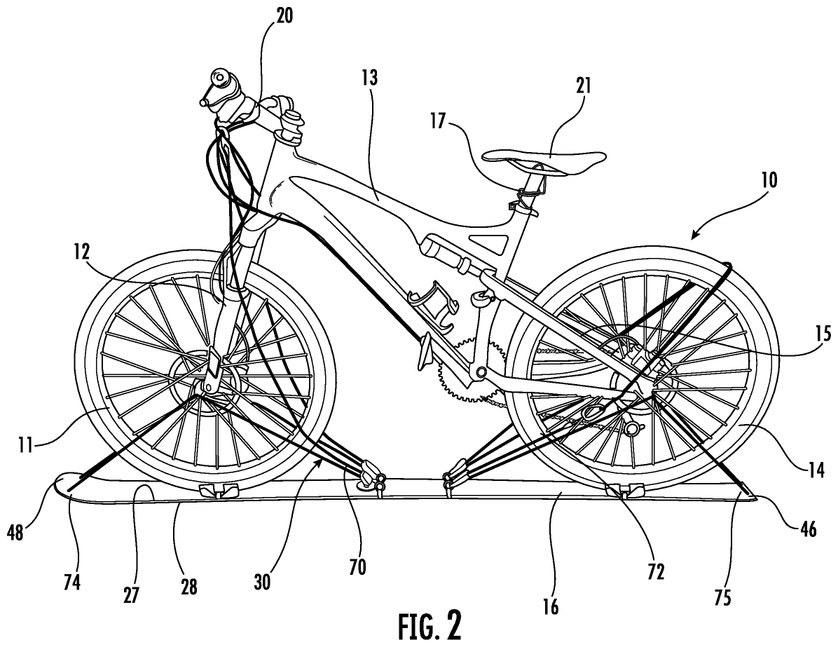

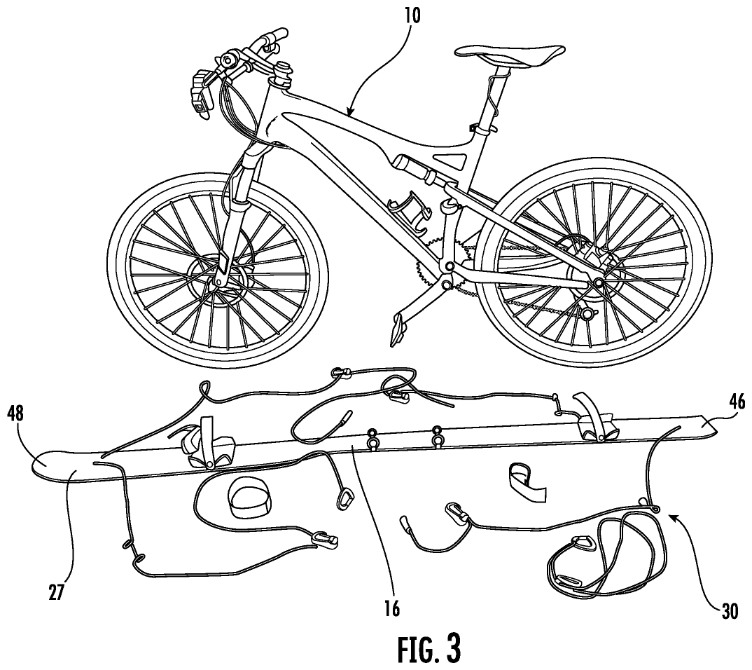

In accordance with the invention, bicycle 10 is adjustable between a wheeled configuration as shown in FIG. 1 and a skied configuration as shown in FIG. 2. In the wheeled configuration ski 16 is coupled to frame 13, or more specifically, coupled to seat post 21 and frame 13 with ski 16 positioned to not hinder use of bicycle 10. In the skied configuration as shown in FIG. 2, front wheel 11 and rear wheel 14 are positioned adjacent a top surface 27 of ski 16 with an opposing bottom surface 28 of ski 16 functioning to providing gliding movement over snow. With additional reference to FIG. 3, an attachment assembly 30 is employed to affix ski 16 to bicycle 10 as will be described presently. Attachment assembly 30 is employed to quickly and easily change bicycle 10 from the wheeled configuration to the skied configuration. Since bicycle 10 is fully assembled in the skied configuration with each element (saddle 21, handle bars 20, etc.) remaining in the same position the cyclist employed when in the wheeled configuration, no additional adjustments to accommodate the rider in the skied configuration are required.

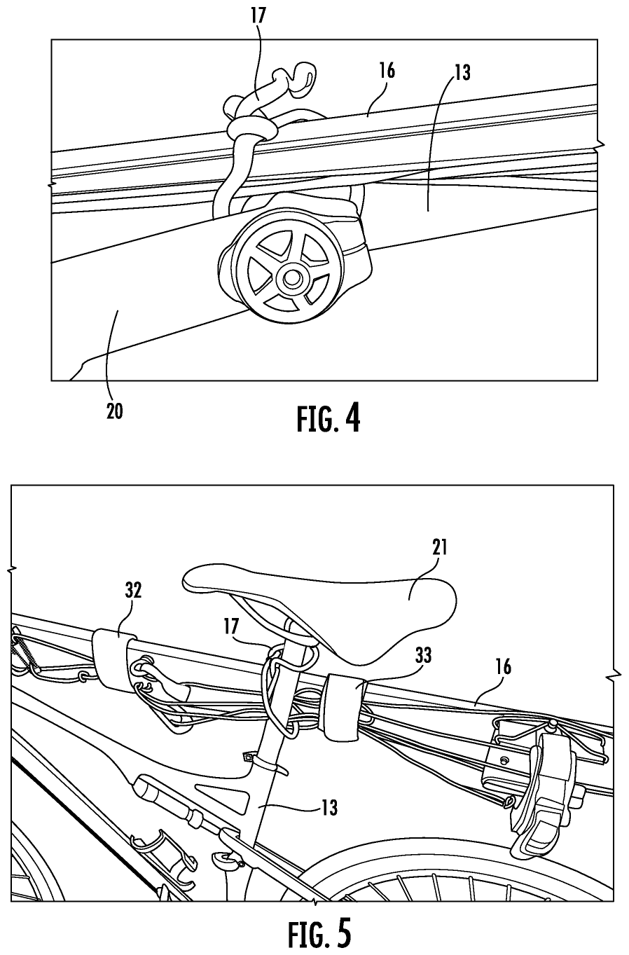

Referring now to FIGS. 4 and 5, in the wheeled configuration, ski 16 and attachment assembly 30 are carried by bicycle 10. With specific reference to FIG. 4, coupling member 17 is a rubberized gear tie which is wrapped about ski 16 proximate of front end thereof and the front of frame 13 proximate handle bars 20. Rubberized gear ties are known and used like twist ties, and therefore will not be described in further detail. With specific reference to FIG. 5, another coupling member 17 is a rubberized gear tie which is wrapped about ski 16 proximate of rear end thereof and seat post 21. In this manner, ski 16 is coupled to bicycle 10 extending adjacent frame 13 below handle bars 20 and seat 21. This positions ski 16 out of the way so normal operation of bicycle 10 can occur without impediment. Still referring to FIG. 5, various elements of attachment assembly 30 which are coupled to ski 16, are captured and generally fixed to ski 16 by ski wraps 32 and 33. Ski wraps 32 and 33 are strips of material having fasteners and complemental fasteners, such as hook and loop fasters like Velcro, buckles, snaps and the like, affixed to opposing ends. Ski wraps 32 and 33 wrap around ski 16 proximate the front and back thereof, respectively, and elements of attachment assembly 30 are held to ski 16. Thus, a wheeled configuration is presented for standard use of bicycle 10.

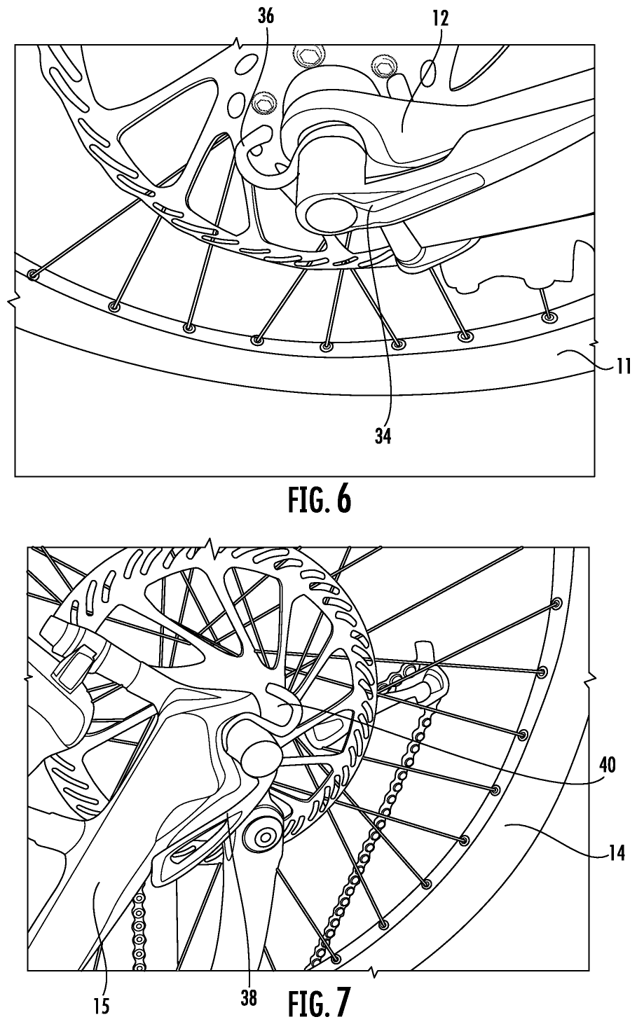

Referring back to FIG. 2, with additional reference to FIGS. 6 and 7, to convert bicycle 10 to the skied configuration, attachment assembly 30 is fitted to bicycle 10 and ski 16. Attachment assembly 30 includes a pair of bindings 42 and 44 configured to receive rear wheel 14 and front wheel 11, respectively, and a pair of tension cord systems 70 and 72 for securing front wheel 11 and rear wheel 14, respectively. Referring specifically to FIG. 6, front wheel 11 is coupled to front fork 12 by a conventional release fastener 34 which can be a quick release or a conventional release fastener. A front axle hanger, preferably a ready connect hook 36 or other similar element like a pulley hanger and the like, is attached between front fork 12 and release fastener 34 on each side of front wheel 11 to the axle points. The front axle hanger, in this case hooks 36, can remain in position in the wheel configuration, ready for use in the skied configuration. Referring specifically to FIG. 7, rear wheel 14 is coupled to rear fork 15 by a release fastener 38 which also can be a quick release or conventional release fastener. A rear axle hanger, preferably a ready connect hook 40 is attached between rear fork 15 and release fastener 38 on each side of back wheel 14 to the axle points. The rear axle hanger, in this case hooks 40 ready connect hooks 40, can remain in position in the wheel configuration, to be ready for use in the skied configuration. Hooks 36 and hooks 40 are part of tension cord systems 70 and 72 for allowing coupling to bicycle 10. While hooks 36 and 40 are preferred, it will be understood that other elements which will fulfill this function can also be employed, such as small pulley hangers and the like.

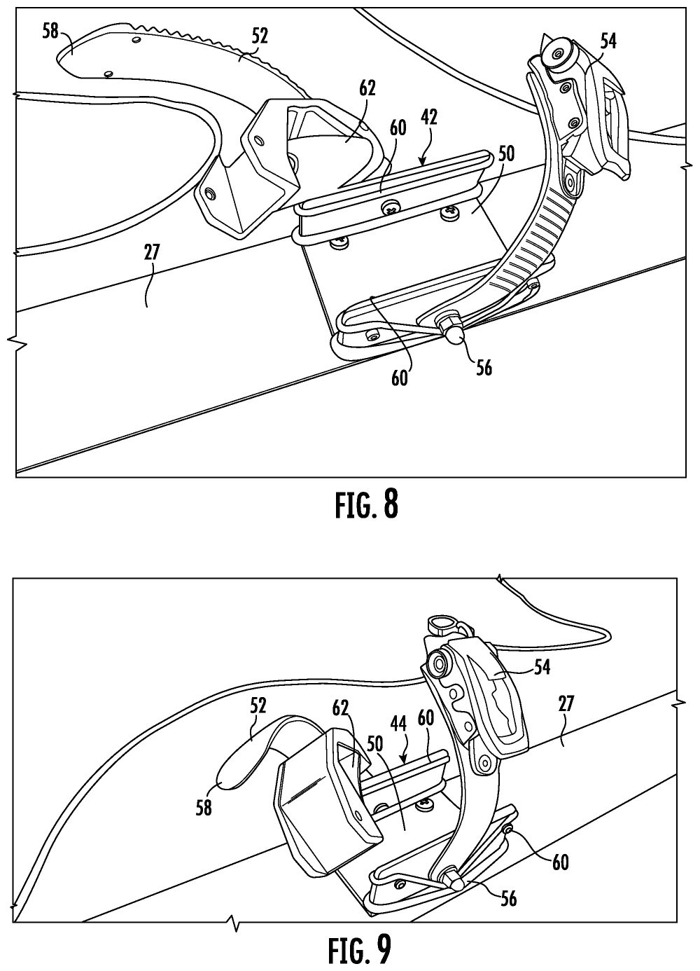

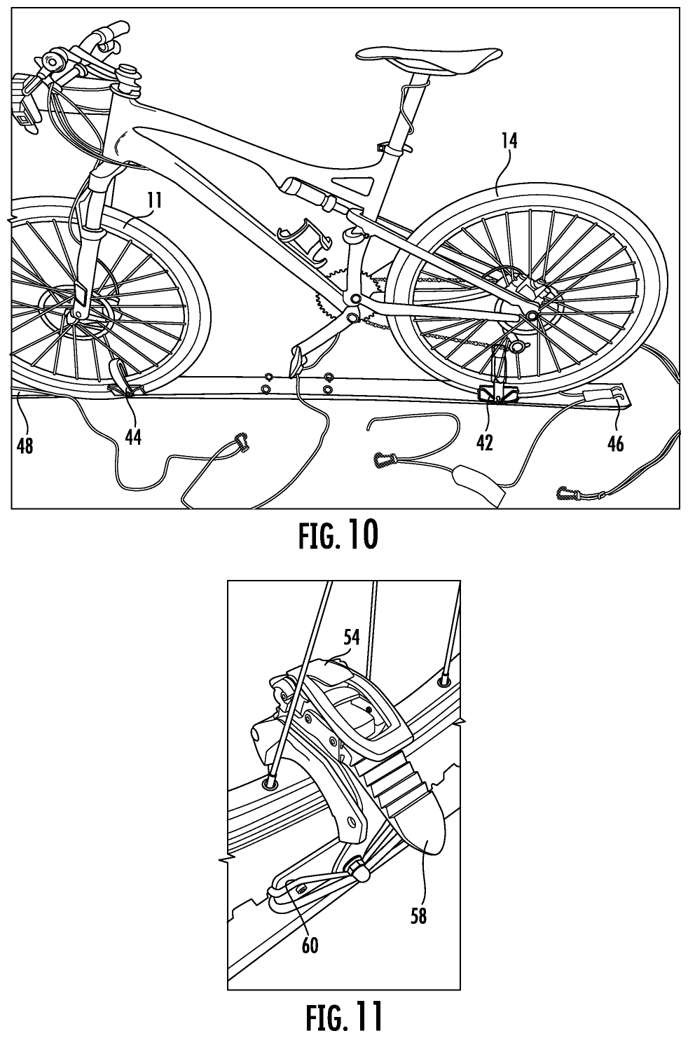

Turning now to FIGS. 8 and 9, rear wheel wedge binding 42 and front wheel wedge binding illustrated, respectively. Since each is identical to the other, one description with reference numbers will be given with the reference numbers indicating both front and rear wheel wedge bindings 42 and 44. With momentary reference to FIG. 10, it can be seen that rear wheel wedge binding 42 is positioned proximate a rear end 46 of ski 16 and front wheel wedge binding 44 is positioned proximate a front end 48 of ski 16. Both rear wheel wedge binding 42 and front wheel wedge binding 44 include a rigid base 50 having attached closable strap 52. Strap 52 is constructed of rugged nylon or canvass and preferably polymer material. Base 50 has a substantially U-shape cross-section, is constructed of metal or strong plastic and is secured against top surface 27 of ski 16 with screws, rivets, adhesive, and the like. Strap 52 is securely attached to one side of base 50 and buckle 54 is securely attached to the other side of base 50. Fasteners 56 such as rivets, screws, adhesive or the like are employed for securing strap 52 and buckle 54 to base 50, and free end 58 of strap 52 is adjustably, securely and releasably engageable to buckle 54. Strap 52, like buckle 54, may be secured to opposing sides of base 50 if desired. Buckle 54 is a closable ratchet type buckle and strap 52 is a ratchet type strap and this arrangement is readily known as being a very rugged form of buckling attachment in connection with many types of known ski boots and ski board bindings.

With additional reference to FIGS. 10 and 11, rear wheel 14 and front wheel 11 are positioned against respective base 50 of each binding 42 and 44. More particular, each is placed within the respective U-shaped channel. To prevent lateral movement of wheels 11 and 14 within bindings 44 and 42, respectively, O-rings 60 are provided to encircle the upstanding sides of base 50. The thickness of O-rings 60 can be selected determined by the width of wheels 11 and 14. In this manner, different size wheels can be accommodated simply by switching to different thickness O-rings as required. Each strap 52 is drawn so as to overly the rim of respective wheel 11 and 14 and then closed with engagement to buckle 54, which is normally pivoted into an open position and then subsequently pivoted into a closed position. Because ratcheting engagement occurs between strap 52 and buckle 54, strap 52 is capable of being drawn very tightly over respective wheel 11 and 14 in the pivotal closing of buckle 54 for providing an extremely secure attachment between front wheel 11, rear wheel 14 and ski 16. Strap 52 is preferably sized so that when closed, free end 58 will not extend past ski 16 and engage the snow to inhibit ski gliding. Strap 52 is furnished with attached rim bridge 62, which is designed to overly and engage against the rim of wheels 11 and 14 for providing an additional measure of gripping there against when strap 52 is closed and secured.

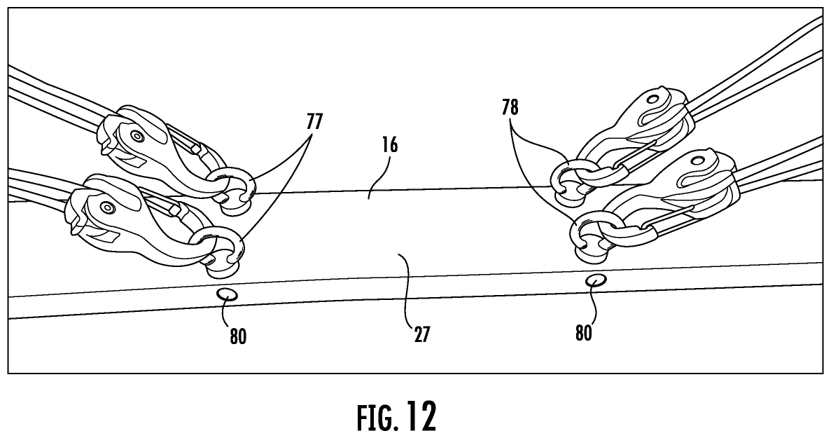

Referring back to FIG. 2, tension cord systems 70 and 72 are illustrated. As described previously, tension cord systems 70 and 72 are coupled to bicycle 10 using hooks 36 and 40. With additional reference to FIG. 12, tension cord systems 70 and 72 are coupled to ski 16 by paired anchors 74 and 75 at front end 48 and rear end 46 of ski 16, respectively, and by paired eyebolts 77 and 78, respectively, carried intermediate bindings 44 and 42. Eyebolts 77 and 78 are coupled to barrel nuts 80 inset through the side of ski 16 in the thickened middle portion thereof. By inserting barrel nuts 80 through the side, and attaching eyebolts through top surface 27, eyebolts are securely and rigidly held in position and bottom surface 28 is untouched so sliding engagement with snow is unhindered.

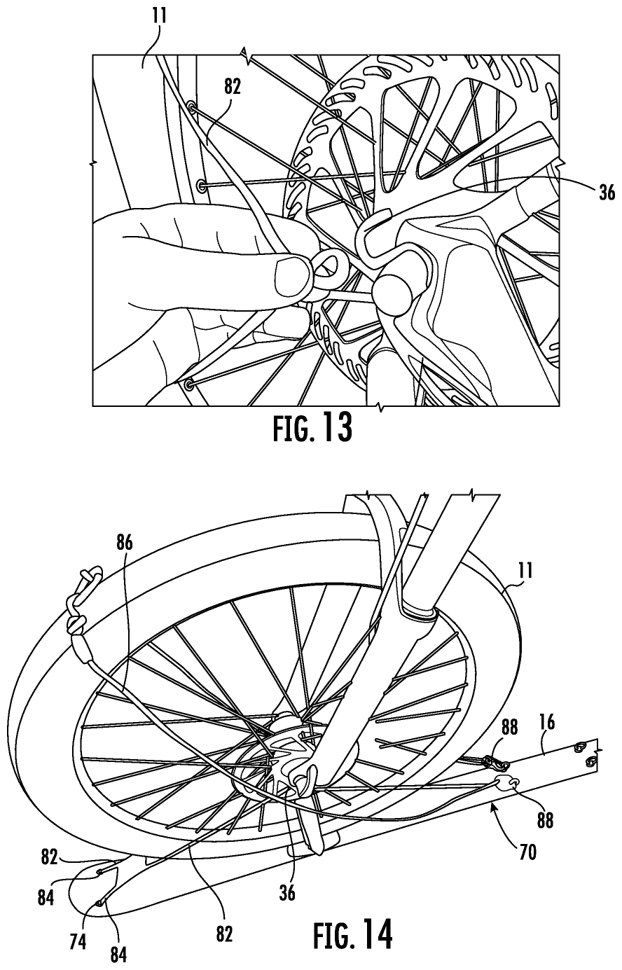

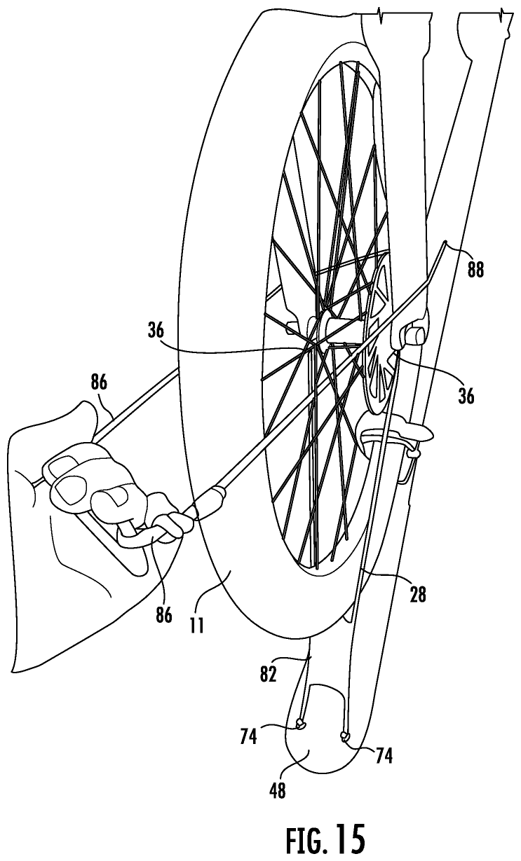

Referring now to FIGS. 14 and 15, front tension cord system 70 includes a pair of cords 82 each having an end 84 and an opposing end 86. Each end 84 is attached to one of anchors 74 with cords 82 passing on either side of wheel 11 to be coupled to one of eyebolts 77 by a tightening carabiner 88. Cords 82 are looped onto the hooks 36 on the corresponding side of wheel 11 as shown in FIG. 13. Opposing end 86 is passed through tightening carabiner 88 and looped forwardly for both opposing ends 86 to be coupled together forward of wheel 11. Tightening carabiners 88 combines a strong carabiner with a cam locking mechanism, allowing a user to secure, tension, and connect serious loads using a rope or cord. Tightening carabiners 88 are clipped to eyebolts 77 and opposing ends 86 are slid through the respective cam mechanism of the associated tightening carabiners 88 for a secure and tightenable engagement. Once positioned with one of the pair of cords 82 to either side of wheel 11, coupled opposing ends 86 are pulled forwardly to tighten pair of cords 82 between anchors 74, hooks 36 and tightening carabiner 88.

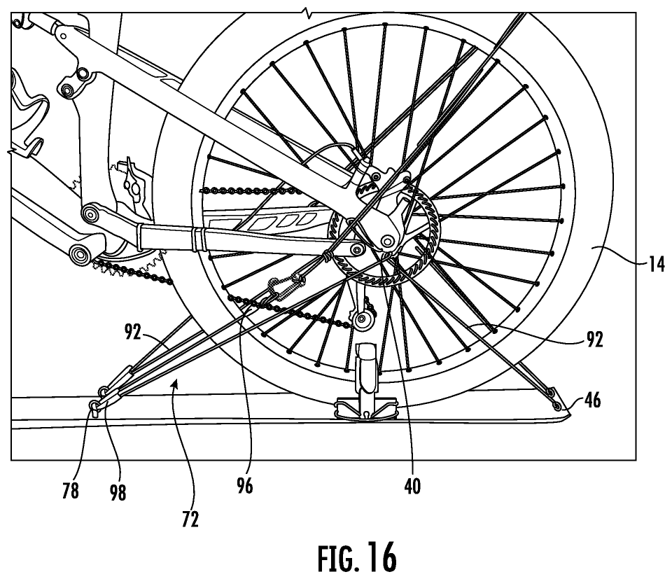

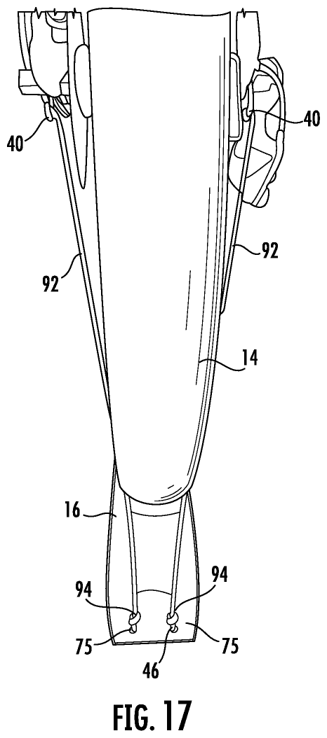

Referring now to FIGS. 16 and 17, rear tension cord system 72 includes a pair of cords 92 each having an end 94 and an opposing end 96. Each end 94 is attached to one of anchors 75 with cords 92 passing on either side of wheel 14 to be coupled to one of eyebolts 78 by a tightening carabiner 98. Cords 92 are looped onto the hooks 40 on the corresponding side of wheel 14. Opposing end 96 is passed through tightening carabiner 98 and looped forwardly for both opposing ends 96 to be coupled together rearward of wheel 14. Tightening carabiners 98 combines a strong carabiner with a cam locking mechanism, allowing a user to secure, tension, and connect serious loads using a rope or cord. Tightening carabiners 98 are clipped to eyebolts 78 and opposing ends 96 are slid through the respective cam mechanism of the associated tightening carabiners 98 for a secure and tightenable engagement. Once positioned with one of the pair of cords 92 to either side of wheel 14, coupled opposing ends 96 are pulled rearwardly to tighten pair of cords 92 between anchors 75, hooks 40 and tightening carabiner 98.

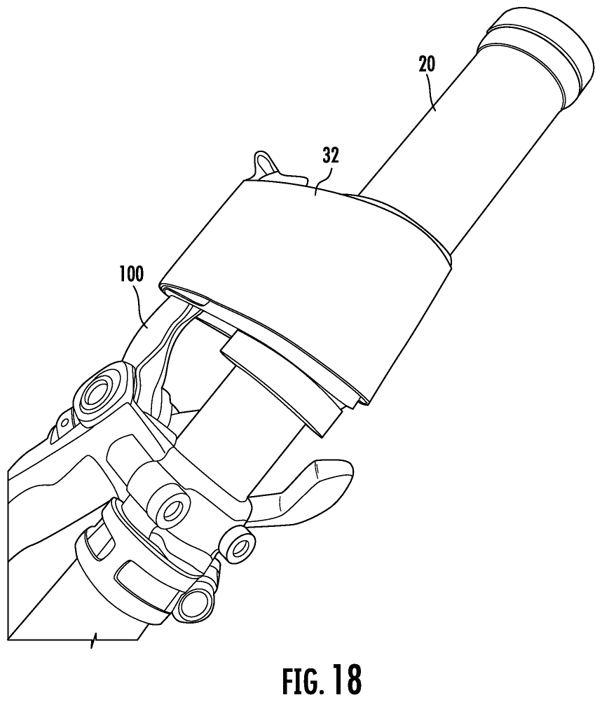

Referring now to FIG. 18, while ski 16 is securely coupled to bicycle 16 using bindings 42 and 44, and tension cord systems 70 and 72, movement of wheels 11 and 14 are further prevented by using ski wraps 32 and 33. With wheels 11 and 14 clamped in their respective bindings 42 and 44, ski wraps 32 and 33, are each wrapped around handlebar 20 and a brake lever 100 so that both the front and rear brake levers are fully squeezed and the brake is fully engaged/locked. This will aid in preventing any front-to-back rolling motion and strain on bindings 42 and 44 when engaging the tension cord systems 70 and 72.

In accordance with this disclosure, bicycle 10 is adjustable between a wheeled configuration (FIG. 1) and a skied configuration (FIG. 2). In the wheeled configuration, front and rear wheels 11, 14 are attached to front and rear forks 12, 15, respectively, and ski 16 is attached to frame 13 with coupling member 17 as explained previously. In the skied configuration, front wheel 11 and rear wheel 14 are attached to ski 16 with attachment assembly 30 as explained previously. In the wheeled configuration, bicycle 10 can be ridden in a conventional manner. In the skied configuration, bicycle 10 can be ridden to ski over a snowy surface, with ski 16 providing a gliding traverse over the snow.

Various changes and modifications to the embodiments herein chosen for purposes of illustration will readily occur to those skilled in the art. To the extent that such modifications and variations do not depart from the spirit of the invention, they are intended to be included within the scope thereof, which is assessed only by a fair interpretation of the following claims.

Having fully described the invention in such clear and concise terms as to enable those skilled in the art to understand and practice the same, the invention claimed is:

1. A ski system for a bicycle comprising:
bicycle including a frame having a front fork, a first release fastener releasably coupling a front wheel to the front fork, a rear fork, and a second release fastener releasably coupling a rear wheel to the rear fork;
a ski having a front end and a back end, the ski attachable to the frame in a wheeled configuration and attachable to the wheels in a skied configuration; and
an attachment assembly removably securing the front wheel and the rear wheel to the ski in the skied configuration, the attachment assembly comprising:
a front binding attached to the ski proximate the front end and removably receiving the front wheel in the skied configuration;
a rear binding attached to the ski proximate the rear end and removably receiving the rear wheel in the skied configuration;
a front tension cord system couplable between the ski and the front wheel in the skied configuration; and
a rear tension cord system couplable between the ski and the rear wheel in the skied configuration.

2. The ski system for a bicycle as claimed in claim 1 wherein the front binding and rear binding each further comprise:
a rigid base;
a buckle securely attached to a side of the base; and
a strap securely attached to an opposing side of the base, the strap having a free end adjustably and releasably engageable to the buckle.

3. The ski system for a bicycle as claimed in claim 2 wherein the rigid base has a U-shaped cross-section sized to receive one of the front wheel and the rear wheel therein in the skied configuration, the strap and buckle engaging over a rim of the one of the front wheel and the rear wheel.

4. The ski system for a bicycle as claimed in claim 2 Wherein the buckle is a closable ratchet type buckle and the strap is a ratchet type strap to form an adjustable ratchet system when engaged.

5. The ski system for a bicycle as claimed in claim 1 wherein the front tension cord system further comprises:
a pair of axle hangers mounted one on either side of the front wheel at the axle points and captured between the first release fastener and the front fork;
a pair of anchors formed in the ski proximate the front end thereof;
a pair of tightening carabiners attached to the ski rearwardly of the front binding; and
a pair of tension cord each having an end attached to one of the pair of anchors, one each engaging one each of the pair of axle hangers, and one each passing through one each of the tightening carabiners, the pair of tensioning cords movable between a loosened configuration and a tightened configuration securing the front wheel to the ski in the skied configuration.

6. The ski system for a bicycle as claimed in claim 5 wherein the tightening carabiners are attached to the ski by a pair of eyebolts carried by the ski.

7. The ski system for a bicycle as claimed in claim 6 wherein the eyebolts are attached to barrel nuts embedded in the side of the ski.

8. The ski system for a bicycle as claimed in claim 5 wherein the rear tension cord system further comprises:
a pair of axle hangers mounted one on either side of the rear wheel at the axle points and captured between the second release fastener and the rear fork;
a pair of anchors formed in the ski proximate the rear end thereof;
a pair of tightening carabiners attached to the ski forward of the rear binding; and
a pair of tension cord each having an end attached to one of the pair of anchors, one each engaging one each of the pair of axle hangers, and one each passing through one each of the tightening carabiners, the pair of tensioning cords movable between a loosened configuration and a tightened configuration securing the rear wheel to the ski in the skied configuration.

9. The ski system for a bicycle as claimed in claim 8 further including coupling members coupling the ski to the frame in the wheeled configuration.

10. The ski system for a bicycle as claimed in claim 1 further including a pair of ski wraps removably attachable to compress hand brake levers into an engaged position when the bicycle is in the skied configuration.

11. A ski bicycle comprising:
bicycle including a frame having a front fork, a first release fastener releasably coupling a front wheel to the front fork, a rear fork, and a second release fastener releasably coupling a rear wheel to the rear fork;
a ski having a front end and a back end, the ski attached to the front wheel and the back wheel; and
an attachment assembly removably securing the front wheel and the rear wheel to the ski, the attachment assembly comprising:
a front binding attached to the ski proximate the front end, the front wheel removably received therein;
a rear binding attached to the ski proximate the rear end, the rear wheel removably received therein;
a front tension cord system coupled between the ski and the front wheel; and
a rear tension cord system coupled between the ski and the rear wheel.

12. The ski bicycle as claimed in claim 11 wherein the front binding and rear binding each further comprise:
a rigid base;
a buckle securely attached to a side of the base; and
a strap securely attached to an opposing side of the base, the strap having a free end adjustably and releasably engageable to the buckle.

13. The ski bicycle as claimed in claim 12 wherein the rigid base has a U-shaped cross-section with one of the front wheel and the rear wheel received therein, the strap and buckle engaging over a rim of the one of the front wheel and the rear wheel.

14. The ski bicycle as claimed in claim 2 Wherein the buckle is a closable ratchet type buckle and the strap is a ratchet type strap to form an adjustable ratchet system when engaged.

15. The ski bicycle as claimed in claim 1 wherein the front tension cord system further comprises:
a pair of axle hangers mounted one on either side of the front wheel at the axle points and captured between the first release fastener and the front fork;
a pair of anchors formed in the ski proximate the front end thereof;
a pair of tightening carabiners attached to the ski rearwardly of the front binding; and
a pair of tension cord each having an end attached to one of the pair of anchors, one each engaging one each of the pair of axle hangers, and one each passing through one each of the tightening carabiners, the pair of tensioning cords movable between a loosened configuration and a tightened configuration securing the front wheel to the ski.

16. The ski bicycle as claimed in claim 15 wherein the tightening carabiners are attached to the ski by a pair of eyebolts carried by the ski.

17. The ski bicycle as claimed in claim 16 wherein the eyebolts are attached to barrel nuts embedded in the side of the ski.

18. The ski bicycle as claimed in claim 15 wherein the rear tension cord system further comprises:
a pair of axle hangers mounted one on either side of the rear wheel at the axle points and captured between the second release fastener and the rear fork;
a pair of anchors formed in the ski proximate the rear end thereof;
a pair of tightening carabiners attached to the ski forward of the rear binding; and
a pair of tension cord each having an end attached to one of the pair of anchors, one each engaging one each of the pair of axle hangers, and one each passing through one each of the tightening carabiners, the pair of tensioning cords movable between a loosened configuration and a tightened configuration securing the rear wheel to the ski.

19. The ski bicycle as claimed in claim 13 wherein the rigid base further includes interchangeable O-rings carried around upright sides of the U-shaped base wedged between the one of the front wheel and the rear wheel received therein preventing lateral movement thereof.
